(19) United States
(12) Patent Application Publication
(10) Pub. No.: US 2012/0074714 A1
(43) Pub. Date: Mar. 29, 2012

(54) DEVICE FOR LOCKING SECOND LEAVES IN THE CLOSED CONFIGURATION

(76) Inventor: Sandro Saccon, Santa Maria Di Sala (IT)

(21) Appl. No.: 13/261,042

(22) PCT Filed: Apr. 19, 2010
(86) PCT No.: PCT/EP2010/055115

§ 371 Date: Nov. 23, 2011

(30) Foreign Application Priority Data
May 25, 2009 (IT) PD2009A000149

(51) Int. Cl. E05C 1/14; E05C 19/16

(52) U.S. Cl. 292/157; 292/138; 292/164

(57) ABSTRACT

Device for locking second leaves, for example of a door with two leaves, in the closed configuration, comprising a recessed button, which is pivoted to a corresponding accommodation body recessed in the side of a second leaf, and which is designed to be pushed in rotation, causing, by means of a transmission element, the retraction, towards the inside of the second leaf, of a latch that is normally pushed vertically towards the architrave or upper cross-member or towards the floor, in engagement in a corresponding seat for locking the second leaf.

### BACKGROUND OF THE INVENTION

Nowadays latches of the ‘lever’ type are known and widespread, for locking a second leaf, for example of a door with two leaves, in the closed configuration.

A lever latch is recessed in the side of a second leaf with which it is associated and which faces, in the closed configuration, the corresponding first leaf.

Such latch comprises a metal body containing an operating lever which is kinematically connected to a bar designed to be extracted for engagement in a corresponding hole, in the closed configuration, in the second leaf, and retractable inside such leaf for opening such second leaf.

The lever must generally be rotated through 180° to pass from an extracted configuration to a retracted configuration of the bar.

Such lever is located, in the two opposite stroke limit configurations, in one of two opposing contoured spaces for containing it internally in such a way that it does not protrude from the metal body, but stays below the surface of the edge of the leaf.

The spaces have recesses for gripping the end of the lever.

Such spaces are generally deep and wide enough to allow gripping only with the last phalanx of a finger.

Such lever latches suffer a number of drawbacks, the first of which is indeed the general difficulty of gripping and the lack of manoeuvrability of the free end of the lever.

The manoeuvrability of such lever is degraded over time because the movement of the latch becomes more difficult and requires greater force to be applied by the user upon the lever to produce the movement of the locking bar for entering or exiting from the leaf.

In addition, such known lever latches require an initial opening action, and a second closing action, with the closing action often being accompanied by the free hand which assists in the correct positioning of the second leaf with respect to the hole in the architrave, or in the upper cross-member, and/or in the floor, for the operation of causing the bar to move out of the latch for locking such second leaf.

In addition such latches generally present spaces for gripping the end of the lever that do not permit them to be gripped easily, with the risk of breaking the fingernail of the phalanx used or of injury.

Lastly, generally, each second leaf has two such lever latches, an upper one for locking the leaf to the architrave, or upper cross-member, of the frame, and a lower one for locking to the floor.

The use of two latches implies two operations by a user for opening the second leaf, and two operations for closing it again, and in two of such operations such user is uncomfortably bent down towards the ground.

### SUMMARY OF THE INVENTION

The aim of the present invention is to provide a device for locking second leaves in the closed configuration that is capable of overcoming the cited drawbacks of lever latches of the known type.

Within this aim, an object of the invention is to provide a device that is simpler to operate than known latches.

Another object of the invention is to provide a device that is less dangerous to a user yet no less effective.

A further object of the invention is to provide a device that is simple to install in the leaves of doors, windows, cupboards, wardrobes and the like, in the same way as known latches.

Another object of the invention is to provide a device that with a single operation releases, for opening, the leaf with which it is associated both from the floor and from the architrave of the frame; such device requires for closing merely that the leaf be pushed towards the locked position.

A further object of the invention is to provide a device for locking second leaves in the closed configuration that is structurally simple and easy to use, and can be produced at low cost.

This aim, as well as these and other objects which will become better apparent hereinafter, are achieved by a device for locking second leaves in the closed configuration, characterized in that it comprises a recessed button, which is pivoted to a corresponding accommodation body and which is designed to be pressed and turned, producing, by means of a transmission element, the retraction of a latch that is normally pushed vertically towards the architrave or upper cross-member or towards the floor, in engagement in a corresponding seat for locking the second leaf with which the device is associated.

### BRIEF DESCRIPTION OF THE DRAWINGS

Further characteristics and advantages of the invention will become better apparent from the following detailed description of six preferred, but not exclusive, embodiments of the locking device according to the invention, illustrated by way of non-limiting example in the accompanying drawings, wherein:

FIG. 1 is a perspective view of a device according to the invention in a first embodiment thereof;

FIG. 2 is a side sectional view of the device of FIG. 1, in a first operative configuration thereof;

FIG. 3 is the same side sectional view of FIG. 2, in a second operative configuration of the device according to the invention;

FIG. 4 is a side view of the device according to the invention in a second embodiment thereof, in a first configuration;

FIG. 5 is a perspective view of the device according to the invention in the second embodiment of FIG. 4, in a second configuration;

FIG. 6 is a side view of a detail of the device according to the invention in the second embodiment of FIG. 5;

FIG. 7 is a first perspective view of the device according to the invention in a fourth embodiment thereof;

FIG. 8 is a second perspective view of the device according to the invention of FIG. 7;

FIG. 9 is a perspective view of the device according to the invention in a fourth embodiment thereof, in a first operative configuration;

FIG. 10 is a further perspective view of the device according to the invention as in FIG. 9, in a second operative configuration;

FIG. 11 is a perspective view of the device according to the invention in a fifth embodiment thereof;

FIG. 12 is a perspective view of the device according to the invention in a sixth embodiment thereof.

### WAYS OF CARRYING OUT THE INVENTION

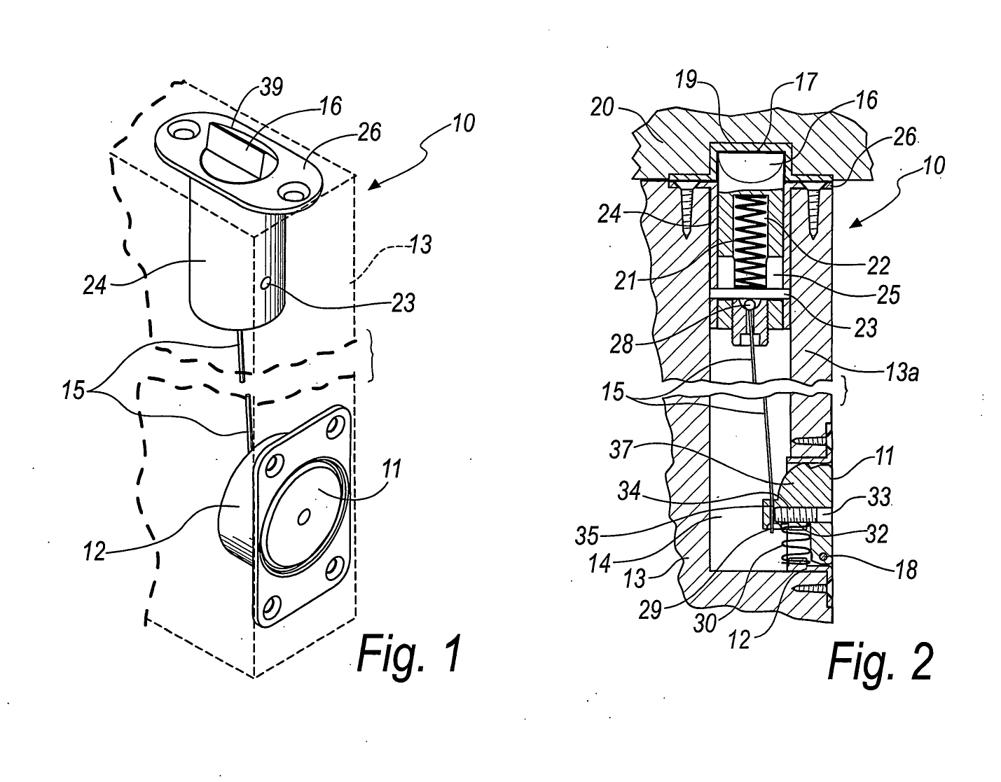

With reference to the figures, a device for locking second leaves in the closed configuration, according to the invention, is generally designated, in its first embodiment shown in FIGS. 1 to 3, by the reference numeral 10.

The device 10 comprises a recessed button 11 which is pivoted to a corresponding accommodation body 12.

The accommodation body 12 is recessed in a second leaf 13, in a corresponding seat 14 formed in the second leaf 13.

The button 11, which is pivoted to the accommodation body 12 by means of the pivot 18, is designed to be pushed, by the manual action of a user, towards the inside of the body 12 and therefore of the leaf 13 itself.

The rotation of the button 11 produces, by means of a transmission element 15, the retraction towards the inside of the leaf 13 of a latch 16, which is normally pushed vertically towards the architrave in engagement in a corresponding seat 17 to lock the leaf 13.

The seat 17 is formed on a plate 19 set into the architrave 20, or into the upper cross-member.

The latch 16 is pushed by a helical spring 21 which is in turn compressed between an axial recess 22 formed inside the body of the latch 16 and a pin 23 which is fixed transversely to a sleeve 24.

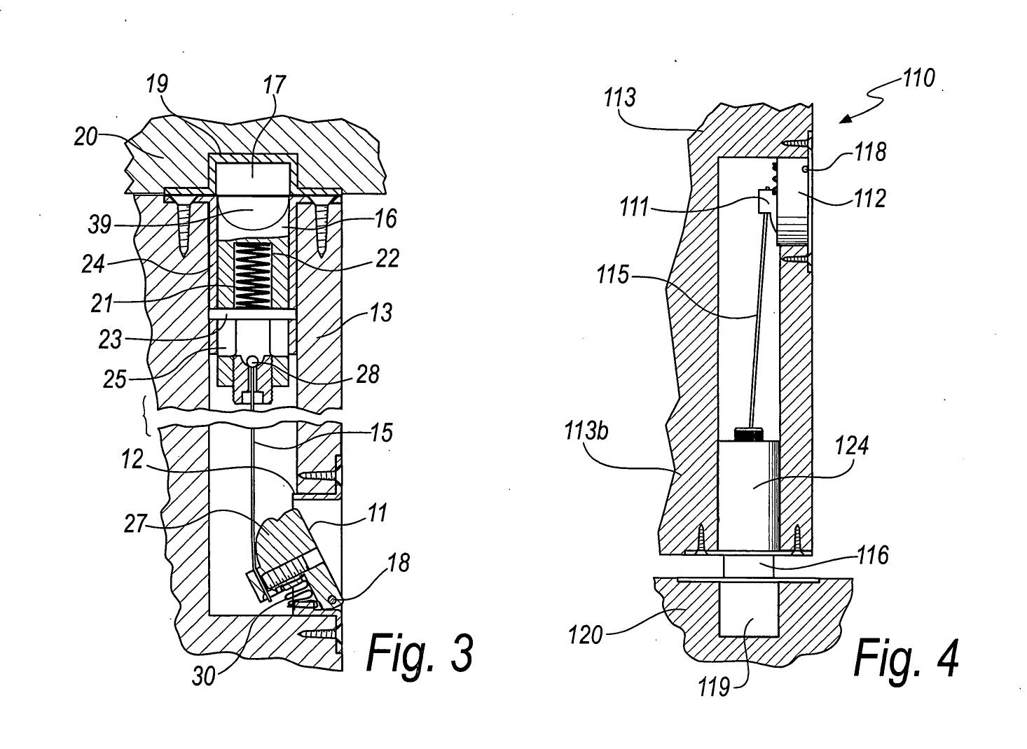

The sleeve 24 contains the latch 16, which is free to perform a translational motion in the sleeve 24, between a fully extracted configuration, schematically shown in FIGS. 1 and 2, and a fully retracted configuration, completely inside the leaf 13, schematically shown in FIG. 3.

The stroke of the latch is delimited by the height of a slot 25 which passes through it diametrically, formed on the body of the latch 16 and designed to be crossed by the pin 23, such pin defining the stroke limit for the latch 16, both in one direction and in the opposite direction.

The sleeve 24 is locked in the leaf 13 by a plate 26, screwed to the leaf and contoured to surround the exit hole of the latch 16.

The transmission element 15 is constituted by a tension member, made for example of metal wire, or a metal cable, but it could also be constituted by a rigid rod, pivoted on the button 11 and fixed at the opposite end to the latch 16.

The ends of the transmission element are rotatably coupled, a first end 28 to the internal part of the body of the latch 16, the second and opposite end 29 to a corresponding seat formed on the button 11 on the part facing the inside of the leaf 13.

Between the accommodation body 12 and the button 11 there is an elastic element 30 for the return of the button 11 from the position that produces the retracted configuration of the latch 16 to the initial position in which the configuration of the latch 16 is the extracted configuration.

In particular, in the embodiment described and illustrated by way of non-limiting example of the invention, the elastic element 30 is a helical spring placed between an undercut 32, formed on the inside of the button 11, and the accommodation body 12.

The button 11 has a central hole 33 for the passage, and screwing, of a grub screw 34 for locking the end 29 of the transmission element 15 in a corresponding hole 35, open on the hole 33 and threaded, into which the grub screw 34 is screwed.

In the first embodiment, for the purposes of example, of the invention described herein, the transmission element 15 is a metal wire, and the inside 37 of the button 11 is shaped like an arc, so as to allow the wire to lie on it without being damaged when the button 11 is pushed to rotate towards the inside of the accommodation body.

The device 10 according to the invention works as follows.

When the second leaf 13 is closed, i.e. located below the architrave 20, or upper cross-member, the latch 16 is inserted in the seat 17.

To perform the opening of the second leaf 13 it is necessary and sufficient to press the button 11; the button 11 rotates around the pivot 18, and pulls the transmission element 15, as in FIG. 3.

The transmission element 15 pulls the latch 16 towards the inside of the leaf 13, and the latch 16 exits from the seat 17 thus freeing the second leaf 13, which at this point can be rotated to the open position.

Upon release of the button 11, the elastic element 30 returns the button 11 to the inactive position, and the helical spring 21 again pushes the latch 16 towards the outside of the leaf 13.

The latch 16 is contoured in such a way as to have an inclined wall 39 which is designed to encounter, during the closing movement, the edge of the architrave 20, or upper cross-member, and produce a thrust upon the latch 16 towards the inside of the leaf 13 by the architrave 20, achieving the retraction of the latch 16 in the course of the closing rotation of the leaf 13.

When the latch 16, during the closing movement of the leaf 13, contacts the seat 17, the helical spring 21 produces the exit, substantially sprung, of the latch 16 and the engagement of the latch 16 in the seat 17, to accomplish the stable closure of the second leaf 13.

The device 10, as described in the first embodiment of the invention, by way of non-limiting example, is designed to be applied to the upper part 13a of the second leaf 13, to operate from below upwards.

FIG. 4 shows a second embodiment of the device according to the invention, indicated therein by the reference numeral 110.

Such second embodiment of the device 110 according to the invention is designed to be applied to the lower part 113b of a second leaf 113.

The device 110 presents, similarly to the first embodiment, a latch 116, a sleeve 124 which contains it, a mortise 119 to be recessed in the floor 120 forming a seat 117 for the latch 116, a button 111, an accommodation body 112, and a pivot 118 for the button 111, as well as a transmission element 115.

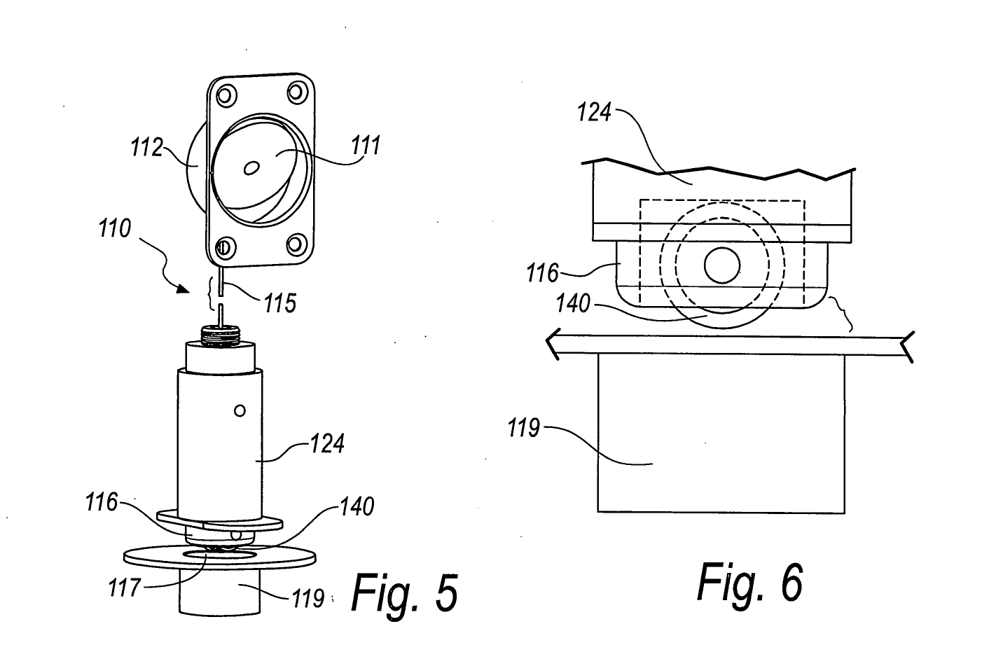

FIGS. 5 and 6 clearly show how the latch 116 has at its end a roller 140, designed to rest on the floor 120, allowing the gliding of the latch 116 upon it without sliding, thus protecting the integrity of the floor.

The operation of the device 110 is the same as of the device 10 in its first embodiment, with the difference that the button 111, once pressed, produces the lifting of the latch 116, while the helical spring inside the sleeve 124, not shown for reasons of simplicity, pushes the latch 116 downwards instead of upwards as in the first embodiment described above.

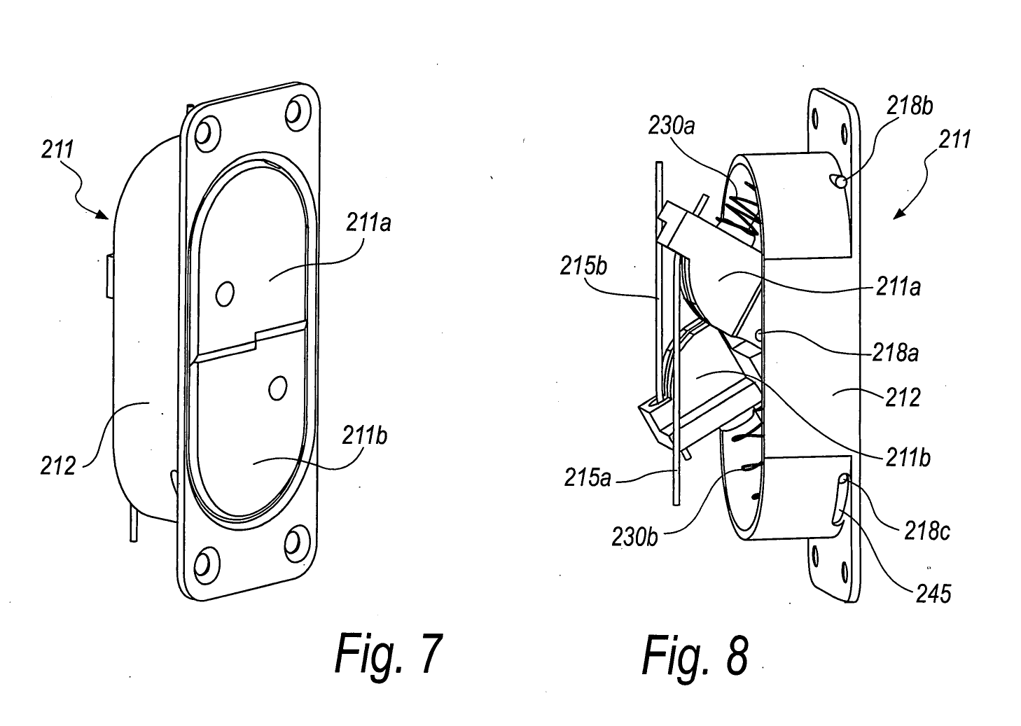

FIGS. 7 and 8 show a device according to the invention in a third embodiment of the same, in which the particularity of the button, indicated by the reference numeral 211, is highlighted.

The button 211 is designed to simultaneously control both an upper latch, like the latch 16 described for the first embodiment, and a lower latch, like the latch 116 described for the second embodiment of the device according to the invention.

The button 211 is thus articulated in two parts 211a and 211b, which are mutually pivoted by means of a first pivot 218a, and each part is pivoted to the accommodation body 212 by means of a second pivot 218b and 218c respectively.

One of the two second pivots, for example the second lower pivot 218c, is also free to perform a translational motion in corresponding slots 245 formed on the accommodation body 212.

There are two elastic elements, 230a and 230b respectively, for the return of the button 211, one for each of the two parts 211a and 211b of the button 211.

A transmission element is associated with each part of the button 211, a first transmission element 215a for the first part 211a of the button 211, and a second transmission element 215b for the second part 211b of the button 211.

The first transmission element 215a controls a lower latch; the second transmission element 215b controls an upper latch, as described in the two previous embodiments of the invention.

When a user presses the button 211 in the middle, a rotation is obtained towards the inside of the two parts 211a and 211b of the button 211, with the second part 211b which, in addition to rotating, returns upwards with its pivot 218c on the accommodation body 212.

The single action on the single button 211 causes the release of both associated latches.

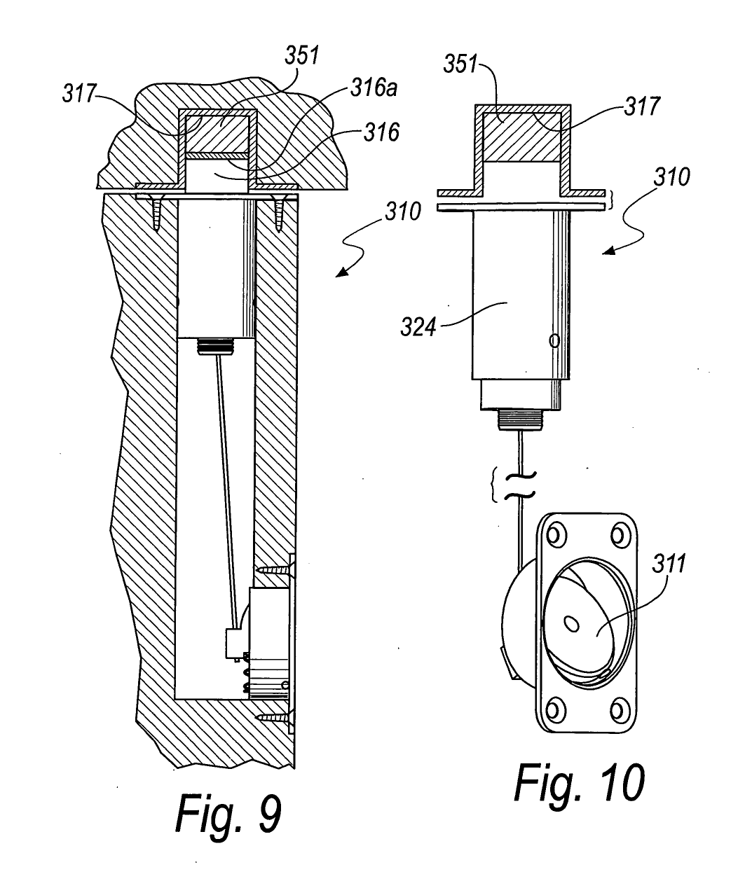

FIGS. 9 and 10 show the device according to the invention in a fourth embodiment thereof, indicated by the reference numeral 310.

The particularity of this embodiment of the invention consists in that the latch 316 is of the magnetic type.

The end 316a of the latch 316 may be of ferromagnetic material, designed to be attracted and attached for closure to an appropriately provided magnetic element 351 arranged in the seat 317 for the latch 316.

FIG. 10 shows the device 310 with the button 311 pressed and the magnetic latch 316 retracted inside the sleeve 324 and the leaf free.

Similarly, a magnetic latch device can be devised for locking the leaf to the floor.

FIG. 11 shows a fifth embodiment of the device according to the invention, indicated therein by the reference numeral 410.

The particularity of the device 410 consists in that the accommodation body 412 for the button 412 and the plate 426, contoured to surround the exit hole of the latch 16 and to hold the sleeve 424 in the leaf, are part of a single supporting body 460, shaped like an L in the example described.

To the L-shaped single body 460, both the accommodation body 412 for the button 411 and the sleeve 424 that contains the latch 416 are then fixed.

A similar structure for the device 410 is simple to install.

The device 410 is devised for locking the second leaf to an architrave, or upper cross-member.

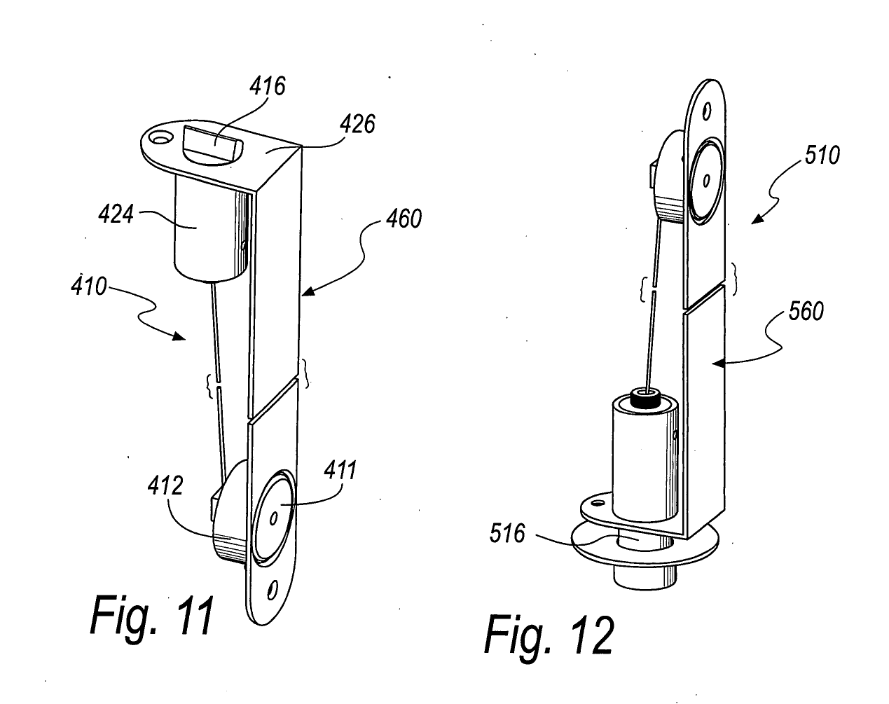

The device according to the invention in its sixth embodiment in FIG. 12, indicated therein by the reference numeral 510, has a similar single supporting body 560, which however carries a latch 516 for locking the leaf to the floor, and therefore to be applied to the lower part of such second leaf.

In practice it has been found that the invention fully achieves the intended aim and objects.

In particular, with the invention a device has been developed that is simpler to operate than known lever latches, and that is easy to use even by users with reduced physical capacities, owing to the button 11, which needs only to be pressed to cause the retraction of the latch 16 and the opening of the second leaf with which the device 10 is associated, whereas for closing such leaf it is sufficient to push such second leaf until it reaches the position of sprung insertion of the latch 16 into the corresponding seat 17 or into the mortise 117.

In addition, with the invention a device has been developed that is less dangerous to a user yet no less effective, since there is no danger to a user's finger in pressing the button 11, which upon being released is pushed into the normal inactive position by the elastic return element 30, and in this way spaces are avoided in which a user's finger could get stuck, or in which it could be injured.

Further, with the invention a device has been developed that is simple to install in the leaves of doors, windows, cupboards, wardrobes and the like, in the same way as known latches, especially in the embodiment with a single supporting body 460 and 560.

Moreover, with the invention a device has been developed which with a single button 211 is able to control both an upper latch and a lower latch, greatly simplifying the operations of opening a second leaf fitted with two lever latches of the known type.

Further, with the invention a device for locking second leaves in the closed configuration has been devised that is structurally simple and easy to use, and which can be produced using known systems and technologies, and at low cost.

The invention, thus conceived, is susceptible of numerous modifications and variations, all of which are within the scope of the appended claims; in addition, all the details may be replaced by other technically equivalent elements.

In practice the materials employed, as well as the dimensions and the contingent shapes, may be any according to requirements and to the state of the art.

The disclosures in Italian Patent Application No. PD2009A000149 from which this application claims priority are incorporated herein by reference.

Where technical features mentioned in any claim are followed by reference signs, such reference signs have been inserted for the sole purpose of increasing the intelligibility of the claims and accordingly such reference signs do not have any limiting effect on the interpretation of each element identified by way of example by such reference signs.

1-9. (canceled)

10. A device for locking second leaves in a closed configuration, comprising a recessed button, which is pivoted to a corresponding accommodation body and is designed to be pressed and turned towards the inside of the body and of a second leaf, causing, by means of a transmission element, retraction of a latch that is normally pushed vertically towards the architrave or upper cross-member or towards the floor, in engagement in a corresponding seat for locking the second leaf with which the device is associated.

11. The device according to claim 10, wherein said latch is pushed by a helical spring, which in turn is compressed between an axial recess formed inside the body of the latch and a pin which is fixed transversely to a sleeve, said sleeve containing the latch, which is free to perform a translational motion in said sleeve between a fully extracted configuration and a fully retracted configuration, the stroke of the latch being delimited by the height of a slot that passes through it diametrically, is formed in the body of the latch and is designed to be crossed by the pin, said pin defining the stroke limit for the latch in both directions.

12. The device according to claim 10, wherein said transmission element is constituted by a tension member, for example a wire or metal cable, a rod or another similar element.

13. The device according to claim 10, wherein an elastic element is interposed between the accommodation body and the button for the return of the button from a position that causes the retracted configuration of the latch to an initial position in which the configuration of the latch is an extraction configuration.

14. The device according to claim 10, wherein it is preset for application to a lower part of a second leaf, said latch having a roller at the end, designed to rest on the floor, allowing the gliding of the latch thereon without sliding.

15. The device according to claim 10, wherein said button is designed to simultaneously control both an upper latch and a lower latch.

16. The device according to claim 15, wherein said button is articulated in two parts, which are pivoted to each other by means of a first pivot, and each part is pivoted to the accommodation body by means of a respective second pivot, one of the two second pivots being free to perform a translational motion in corresponding slots formed in said accommodation body, said button having two elastic elements for the return of the button, one for each one of the two parts of the button, a transmission element being associated with each part of the button, the first transmission element controlling a lower latch, the second transmission element controlling an upper latch.

17. The device according to claim 10, wherein the latch is of the magnetic type and has an end made of ferromagnetic material designed to be attached for closure to a magnetic element arranged in the seat.

18. The device according to claim 10, wherein the accommodation body for the button and a plate, contoured to surround the exit hole of the latch and to block a sleeve in the leaf, are part of a single supporting body.
